(19) United States
(12) Patent Application Publication
(10) Pub. No.: US 2017/0191526 A1
(43) Pub. Date: Jul. 6, 2017

(54) ROTATION RESISTANT LINEAR BEARING ASSEMBLY

(71) Applicants: Jonathan Brooks Horner, Everett, WA (US); Jacob Adam Beckwith, Renton, WA (US)

(72) Inventors: Jonathan Brooks Horner, Everett, WA (US); Jacob Adam Beckwith, Renton, WA (US)

(21) Appl. No.: 15/368,568

(22) Filed: Dec. 2, 2016

Related U.S. Application Data
(60) Provisional application No. 62/274,824, filed on Jan. 5, 2016.

(51) Int. Cl. F16C 29/04; F16C 43/06

(52) U.S. Cl. CPC F16C 29/045; F16C 43/06

(57) ABSTRACT

A roller bearing assembly configured to guide linear movement of a shaft with a polygonal cross section. The roller bearing assembly includes a housing unit, which may contain a centrally-placed hole for mounting the assembly, and a plurality of cavities on the surface of both ends of the housing unit. The bearing assembly further includes a plurality of axially-displaceable roller bearings placed in one or more sets of pairs in the cavities of the housing. The roller bearings contact the shaft to guide movement axially and to resist torque, and thereby prevent the rotation of the shaft relative to the housing unit.

### FIELD OF THE DISCLOSURE

This disclosure relates generally to the field of linear bearing assemblies. More particularly, the invention relates to a linear roller bearing assembly configured to resist rotation of a shaft and allows for movement of the shaft along an axis.

### BACKGROUND

Bearing assemblies are commonly found in agricultural machinery, machine tools, home power tools, and in sporting equipment. A wide variety of structures and techniques are known and are commonly in use in the field of bearings. Such assemblies include plain (or sleeve) bearings, and bearings incorporating bearing elements, such as rollers, balls, and so forth. The bearings can be further categorized according to the motion of the bearings. One of the motion-specific bearings is the linear-motion bearing, or so called linear bearing or linear slide, which is a bearing designed to provide free motion in one direction. All linear bearings (or slides) provide linear motion based on bearings, whether they are ball bearings, dovetail bearing, linear roller bearings, magnetic or fluid bearings.

Some commonly seen linear bearings, such as machine slides and roller tables, are bearings moved by drive mechanisms. Non-motorized ball bearings and roller slides provide low-friction linear movement for equipment powered by inertia of motion or by hand. Common bearing assemblies can be found in the following referenced U.S. Pat. Nos. 3,659,909, 4,075,872 and 5,156,463, etc. Each reference however, is problematic. Some bearing assemblies only partially resist torque while allowing axial movement of a shaft, where other bearings require brackets or springs to absorb the torque generated by axial movement of the bearings. Still other bearing assemblies fail to reduce sufficient friction on the shaft because they use only one roller bearing rather than pairs or groups of bearings. Other bearing assemblies allow only limited shaft shapes and sizes.

The foregoing illustrates limitations known to exist in present devices and methods. Thus, it is apparent that it would be advantageous to provide an alternative directed to overcoming one or more of the limitation set forth above.

### SUMMARY

The present invention solves the aforementioned problems by allowing the bearing assembly to travel axially along a shaft while preventing to change the assembly's rotational position relative to the shaft. The bearing assembly travels along the axis of a shaft, resisting axial torque by the assembly's multiple roller bearings and contact points.

In one aspect of the invention, this is accomplished by providing a linear roller bearing assembly for guiding axial movement where the bearing assembly uses multiple roller bearings, joined in sets of two or more, thereby further reducing torque due to the additional independent contact points. Some embodiments of the present invention maintain at least two roller bearings on a single plane for each plane of the shaft, thereby vitiating the need for brackets, springs, or other additional structures. Having the bearings on a single plane provides more efficient torque reduction, and also reduces material and weight.

Embodiments of the present invention are more readily scalable than other bearing assemblies, as they may incorporate industry standard components.

Finally, embodiments of the present invention may comprise a rolling assembly, thereby providing a smoother action than sliding assemblies.

The following embodiments and descriptions are for illustrative purposes only and are not intended to limit the scope of the Rotation Resistant Linear Bearing Assembly. Other aspects and advantages of the present disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 is an angled view diagram of an embodiment of the bearing assembly as assembled.

FIG. 2 is an angled view diagram of an embodiment of the bearing assembly with the near end exploded.

FIG. 3A is a length-wise cross-sectional view diagram of an embodiment of the bearing assembly on a shaft.

FIG. 3B is a cross-sectional view diagram perpendicular to a shaft of an embodiment of the bearing assembly on the shaft.

FIG. 4 is an embodiment of the bearing assembly in a golf putting aid coupled with a base and a cantilevered rod.

FIG. 5 is a flow diagram of the method to build the bearing assembly.

all arranged in accordance with at least some embodiments of the present disclosure.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose limit is the second number. For example, 25 to 100 mm means a range whose lower limit is 25 mm and upper limit is 100 mm.

### Definitions

Axial torque: torque about the axis.

The present disclosure is generally drawn, inter alia, to rotation resistant linear bearing assembly.

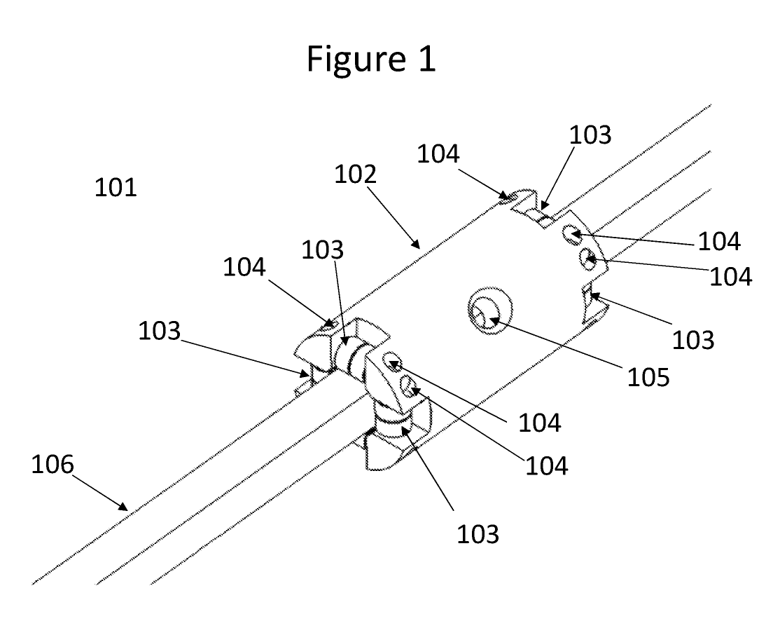

FIG. 1 is an angled view diagram of an embodiment of the bearing assembly as assembled, arranged in accordance with at least some embodiments of the present disclosure. FIG. 1 includes a bearing assembly 101, a housing unit 102, a set of rolling bearings 103, a set of pin holes 104, a hole 105, and a shaft 106. In some embodiments, bearing assembly 101 is easily assembled by hand.

In FIG. 1, bearing assembly 101 fits snugly around shaft 106 such that shaft 106 smoothly rides on the contact points between bearing assembly 101 and shaft 106 and resists torque. Bearing assembly 101 may be comprised of metal, plastic, and other material commonly used in the art. Housing unit 102 is preferably cylindrical but may be non-cylindrical in shape. Housing unit 102 may be any polygonal shape. The manufacturing of housing unit 102 is preferably 3-D printed but may otherwise be forged, molded, or otherwise manufactured in various methods commonly used in the art.

In some embodiments, housing unit 102 may contain centrally-located hole 105 which may be positioned approximately at the midpoint of the length of housing unit 102. In some embodiments, hole 105 may be threaded, countersunk, and otherwise capable of containing a screw or fastener to secure housing unit 102 to an external hollow shaft or cylinder. In some embodiments, housing unit 102 may comprise zero hole 105 for mounting to a larger external apparatus. In some embodiments, housing unit 102 may comprise a plurality of hole 105 for mounting to a larger external apparatus. In some embodiments, housing unit 102 may be held by clamps or other external bracketry. Alternatively, housing unit 102 may be press fit or glued into position. In some embodiments, housing unit 102 may comprise an open side. As with bearing assemblies designed to stabilize power tools, this design may allow for hand use or monitoring.

In some embodiments, the lengthwise end of housing unit 102 may feature a plurality of protrusions formed by a number of cavities caved apart around the edge of the housing end and make an opening to the respective plane of shaft 106. A set of paired pin-holes 104 are positioned on the protrusions of housing unit 102 to hold a set of bearing pins or axles such that bearings 103 riding on their respective pins can roll along shaft 106.

In some embodiments, bearings 103 may be commercially available cylinders functioning as the rollers for shaft 106. Bearings 103 may comprise a plurality of bearing rollers, bearing shapes, and may have the rollers on each plane or different planes that contact shaft 106. Bearings 103 may comprise a ball bearing or any kind of rolling-type bearing. Bearings 103 may be caged ball bearings with races, roller bearings, taper roller bearings, ball bearing rollers, or other rotating wheel. A brass or plastic wheel may roll smoothly enough to not require an actual bearing. One or more rollers may be coupled to each of the pins on bearing assembly 101. Bearing 103 may be coupled to one or more pins and may be of various sizes, generally scaling in size with the housing and shaft. In some embodiments, bearings 103 may be positioned without pins or any type of guides. In some embodiments, bearing assembly 101 may be comprised of enclosed bearings. In some embodiments, bearing assembly 101 may comprise exposed bearings 103.

Bearing assembly 101 may be configured to accommodate shaft 106 of varying shapes and sizes so long as the shape allows bearing assembly 101 to apply force about the axis to resist rotation about shaft 106's axis. In FIG. 1, shaft 106 is square in its cross sectional shape but it may be any polygonal shape. Polygonal shapes include, but are not limited to triangles, rectangles, squares, pentagons, hexagons, cross shape or star shape.

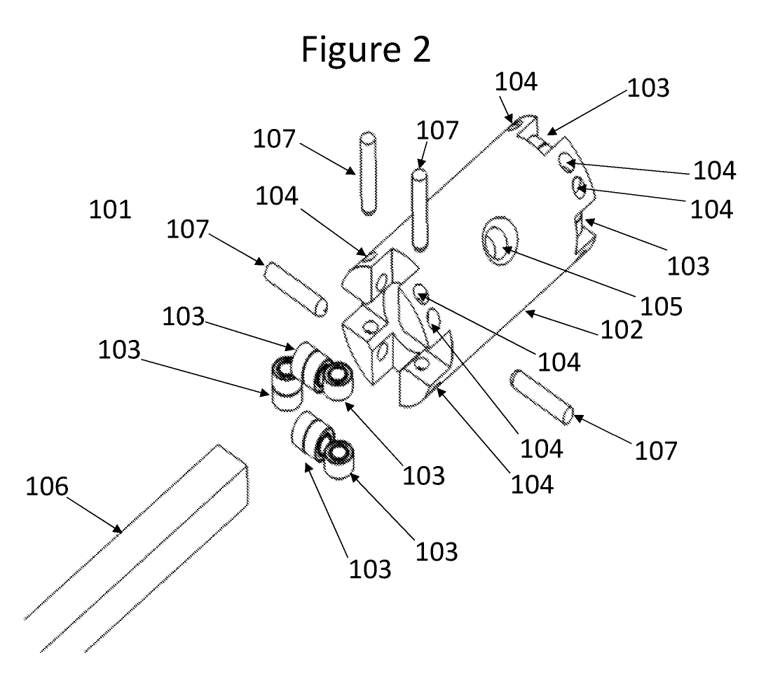

FIG. 2 is an angled view diagram of an illustrated embodiment of the bearing assembly with the near end exploded, arranged in accordance with at least some embodiments of the present disclosure. FIG. 2 includes a bearing assembly 101, a housing unit 102, a set of rolling bearings 103, a set of pin holes 104, a hole 105, a shaft 106, and a set of bearing pins 107.

In the FIG. 2, bearing assembly 101 is configured to receive shaft 106 with a square cross section. Housing unit 102 of bearing assembly 101 includes four sets of two perpendicular pin holes 104 positioned at each end of the housing unit 102, wherein each set of pin holes 104 has one thru-hole paired perpendicularly in axis with another thru-hole. Each set of two perpendicular pin holes 104 is positioned on each cylinder protrusion which is caved at both ends of housing unit 102. The cavities are cut across the ends of housing unit 2, each two perpendicular pin holes 104 centered on the body and running parallel to each pair of holes. At one end of housing unit 102, four sets of two perpendicular pin-holes 104 (two thru-holes for each pin 107) are spaced from one another to hold four bearing pins 107 such that each pin 107 may be positioned in parallel with each plane of shaft 106.

In the preferred embodiment, four thru-holes with the same axial direction are paired to hold two pins 107 in parallel, while the other four thru-holes lay in perpendicular direction to hold the other two pins perpendicular to the other two pins 107. However, pins 107 may not be parallel depending on the polygonal shape of the shaft. In addition, pins 107 may not have a set of bearings on every face of the shaft. For example, a bearing assembly for a pentagon shaped shaft will not have parallel pins and may have bearings on four sides rather than on all five sides. In FIG. 2, bearing assembly 101 further includes four sets of rolling bearings 103. Each set of rolling bearings 103 may contain two or more bearings to be paired for strength and flexibility. Bearings 103 fit in the cavities of housing unit 102. Bearings 103 may be commercially available cylinders, functioning as rollers for shaft 106. Bearings 103 will roll or spin about their respective axles on pins 107 as bearing assembly 101 moves along shaft 106. Housing unit 102 holds pins 107 and bearings 103 in place. Pins 107 fit into the housing unit 102 via welding, screwing, press-fit or other fastening means. Each end of housing unit 102 are arranged symmetrically with the same configuration of cavities, protrusions, bearings 103, and pins 107. In some embodiments, bearings 103 may be positioned within housing unit 102 without pins 107 or other types of axles or guides.

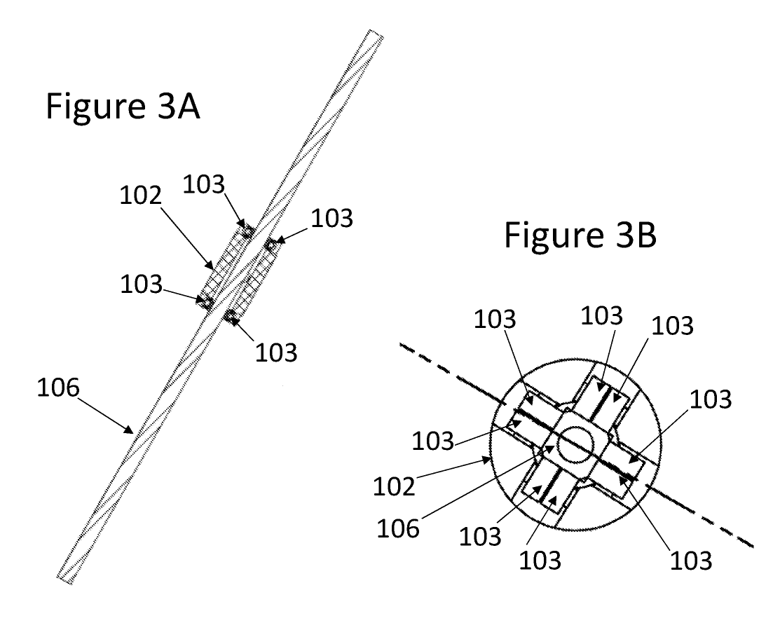

FIG. 3A is a length-wise cross-sectional view diagram of an embodiment of the bearing assembly on a shaft, arranged in accordance with at least some embodiments of the present disclosure. FIG. 3A includes a housing unit 102, a set of rolling bearings 103, and a shaft 106.

FIG. 3B is a cross-sectional view diagram perpendicular to a shaft of an embodiment of the bearing assembly on the shaft, arranged in accordance with at least some embodiments of the present disclosure. FIG. 3B includes a housing unit 102, a set of rolling bearings 103, and a shaft 106.

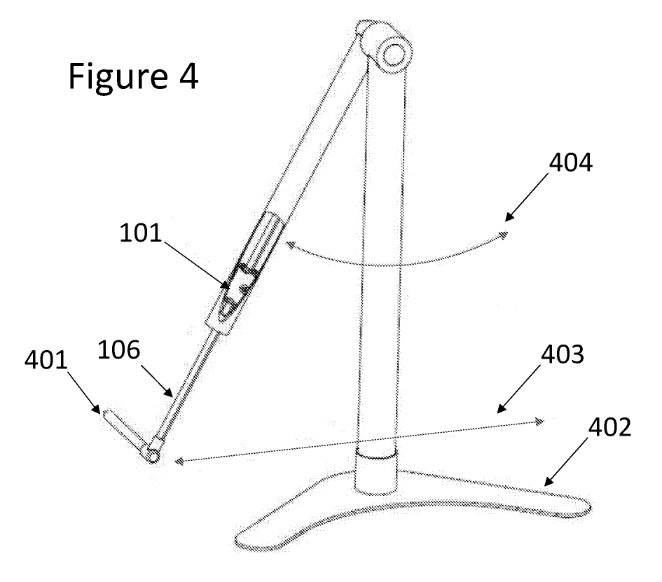

FIG. 4 is a diagram of an embodiment of the bearing assembly in a golf putting aid, arranged in accordance with at least some embodiments of the present disclosure. FIG. 4 includes a bearing assembly 101, a shaft 106, a rod 401, a base 402, a linear travel route 403, and a pivoting travel route 404. The putting device in FIG. 4 helps a golfer practice aligning his or her golf club on a plane. The application accomplishes this training through telescopic motion with a cantilevered arm applying a torque which is counteracted by bearing assembly 101.

In FIG. 4, a golf putter is attached to rod 401. Rod 401 is attached to shaft 106, which rolls through bearing assembly 101 for a smooth swing and up and down movement of shaft 106. A golfer would stand on base 402 to stabilize the base of the apparatus. When the golfer swings the putter, shaft 106 moves up and down during the swing. Bearing assembly 101 in the larger cylinder of the apparatus assures that the axis of the bearings in the top of the apparatus is parallel to the axis of rod 401 to which the putter is attached. By maintaining this relationship, the putter travels in a straight line throughout the swing as shown in linear travel route 403. This straight swing is preferable to an elliptical or jerky swing. Pivoting travel route 404 shows the circular swing of the upper larger cylinder.

Alternate embodiments or uses of bearing assembly 101 comprise a bearing assembly which is part of another assembly which is a muscle memory trainer guiding a user through a swing. In some embodiments, the bearing assembly may be used as a single-arm drawer slider. In some embodiments, the bearing assembly may comprise an adjustable suspension member that resists torque. In some embodiments, the bearing assembly may be used in applications that traditionally use an arrangement of multiple linear bearing assemblies to resist torque.

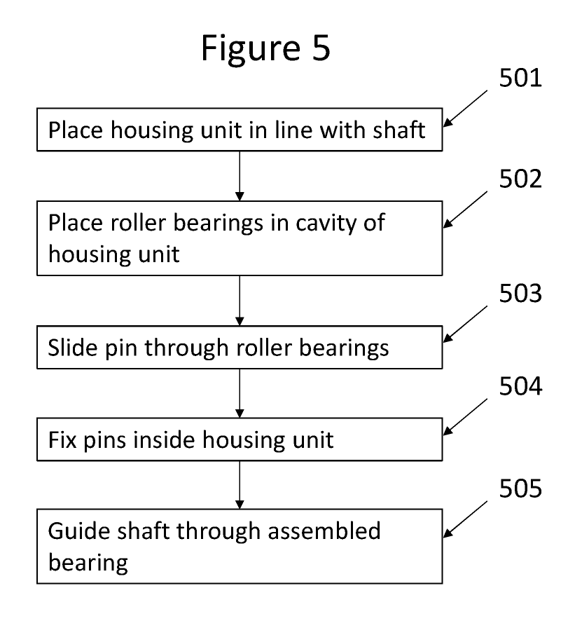

FIG. 5 is a flow diagram of the method to build the bearing assembly, arranged in accordance with at least some embodiments of the present disclosure. FIG. 5 includes a step 501, a step 502, a step 503, a step 504, and a step 505.

In step 501, housing unit 102 is placed in line with shaft 106 but kept separated. In step 502, roller bearings 103 are placed in a cavity of housing unit 102. In step 503, pin 107 is slid into place through bearings 103 and pin holes 104. In step 504, pin 107 is fixed in place inside housing unit 102. Steps 502, 503, and 504 are repeated until all cavities of housing unit 102 are filled with bearings 103 and pins 107. In step 505, shaft 106 is guided through bearing assembly 101.

While preferred and alternate embodiments have been illustrated and described, as noted above, many changes can be made without departing from the spirit and scope of the Rotation Resistant Linear Bearing Assembly. Accordingly, the scope of the Rotation Resistant Linear Bearing Assembly is not limited by the disclosure of these preferred and alternate embodiments. Instead, the scope of the Rotation Resistant Linear Bearing Assembly should be determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. §112 ¶6. In particular, the use of “step of” in the claims herein is not intended to invoke the provisions of U.S.C. §112¶6.

What is claimed is:

1. A rolling bearing assembly for providing guided linear movement of a shaft counteracting axial torque, said bearing assembly comprising:
a housing unit, hollow in the center for receiving the shaft, said housing unit having at least one set of cavities positioned on said housing unit;
a plurality of rolling-element bearings, mounted on pins, which fit into the cavities of said housing unit, said pins positioned parallel with the planes of said shaft to guide the movement of said shaft;
said rolling-element bearings configured to receive and retain the shaft and allow linear movement of the shaft; and
said rolling-element bearings positioned to enable the bearing assembly to resist axial torque.

2. The bearing assembly of claim 1, wherein the assembly parts are constructed of metal, plastic, and other material common in the art.

3. The bearing assembly of claim 1, wherein the housing unit has none or more bolt hole in the side for mounting to another mechanism element.

4. The bearing assembly of claim 1, wherein the housing unit comprises a cylindrical shape.

5. The bearing assembly of claim 1, wherein the housing unit comprises a polygonal shape.

6. The bearing assembly of claim 1, wherein the housing unit has exposed bearings.

7. The bearing assembly of claim 1, wherein the housing unit is designed to enclose the bearings.

8. The bearing assembly of claim 1, wherein the shaft is polygonal in cross sectional shape.

9. The bearing assembly of claim 1, wherein the rolling bearing may be of the types of caged ball bearings with races, roller bearings, taper roller bearings, or ball bearing rollers.

10. The bearing assembly of claim 1, wherein the rolling bearings may have a different number of rolling bearings arranged in contact with different planes of the shaft.

11. The bearing assembly of claim 1, wherein the rolling bearings are enclosed in a cage without guides, pins, or axles.

12. The bearing assembly of claim 1, wherein the rolling bearings may vary in size scaling with the sizes of the housing unit and the shaft.

13. The bearing assembly of claim 1, wherein the bearing assembly comprises an adjustable suspension member that resists torque.

14. The bearing assembly of claim 1, wherein the bearing assembly is part of another assembly for muscle memory training.

15. The bearing assembly of claim 1, wherein the bearing assembly is part of a single-arm drawer slider.

16. The bearing assembly of claim 1, wherein the bearing assembly is part of an application that traditionally uses an arrangement of multiple linear bearing assemblies to resist torque.

17. A bearing assembly method comprising:
a housing unit is placed in line with a shaft but kept separated;
a rolling bearing or set of rolling bearings are placed in a cavity of the housing unit;
a pin is slid into place through the rolling bearing or set of rolling bearings placed in the cavity of the housing unit;
the pin is fixed in place inside the housing unit;
the previous three steps are repeated until the desired cavities of the housing unit are filled with rolling bearings; and
the shaft is guided through the bearing assembly.

18. The method of claim 18, wherein the method is performed by hand.

19. The method of claim 19, wherein the method is performed by machine or a combination of by hand and machine.
